(19) United States
(12) Patent Application Publication
(10) Pub. No.: US 2010/0321672 A1
(43) Pub. Date: Dec. 23, 2010

(54) PROTEIN BASED SHEET MATERIAL FOR IN VITRO TESTING

(75) Inventors: Sebastianus Gerardus Johannes Maria Kluijtmans, Zeist (NL); Marinus Cornelis Van Zundert, Etten-leur (NL); Jan Bastiaan Bouwstra, Bosch en Duin (NL)

Correspondence Address: FOLEY AND LARDNER LLP;SUITE 500, 3000 K STREET NW, WASHINGTON, DC, 20007, US

(73) Assignee: FUJIFILM MAANUFACTURING EUROPE B.B., TILBURG (NL)

(21) Appl. No.: 12/867,711

(22) PCT Filed: Feb. 13, 2009
(86) PCT No.: PCT/NL09/50062

§ 371 Date: Aug. 13, 2010

(30) Foreign Application Priority Data
Feb. 15, 2008 (EP) 08151502

(51) Int. Cl. G01J 3/00; G01B 5/28; C09D 189/00; C08L 89/00; B32B 27/06

(52) U.S. Cl. 356/51; 428/141; 106/124.1; 106/160.1; 106/156.5; 106/156.51; 106/156.2; 524/17; 106/146.1; 106/155.21; 428/412; 428/474.7; 428/476.6; 106/18.32; 427/384

(57) ABSTRACT

The invention provides a sheet material that is of use as an equivalent to skin for in vitro testing of cosmetic ingredients and/or formulations. The sheet material comprises protein and a humidity control agent so that it is ready to use. Tests that can be performed on the sheet material are for example make up smearing, colour evaluation, sun protection factor measurements, UVA-protection, water resistance of cosmetic products, sunless tanning applications, etc.

### FIELD OF THE INVENTION

The present invention is in the field of cosmetic research. Provided is a sheet material or film that is of use as an equivalent to skin for in vitro testing of cosmetic ingredients and/or formulations. Tests that can be performed on the sheet material of this invention are for example make up smearing, colour evaluation, sun protection factor measurements, UVA-protection, water resistance of cosmetic products, sunless tanning applications, etc.

### BACKGROUND OF THE INVENTION

The cosmetic industry introduces many new products. Before introduction onto the market cosmetic products have to be tested for their safety and functional properties. It is a clear trend to avoid the use of animals and human beings for testing purposes. Hence the development of tools for use in in vitro testing methods is very much called for.

The properties to be tested can roughly be divided in two categories: one in which a bio-response is needed (for example: skin irritation, skin sensitization, and skin tanning), the other in which the physical properties of the product play a major role (for example: spreading, de-emulsification, smearing, water fastness). The latter category is particularly suitable to be tested by in vitro methods. The quality of in vitro testing heavily relies on the availability of suitable test substrates. In order to be predictive the test substrate should mimic the human skin as closely as possible. Important parameters are e.g. surface tension, roughness, elasticity, moisture uptake, and adhesion. For light transmission measurements it is particularly desirable that the substrate is transparent.

A sheet material that is currently available is Vitro-Skin®. Vitro-Skin® is an advanced testing substrate that effectively mimics the surface properties of human skin. It contains both optimized protein and lipid components and is designed to have topography, pH, critical surface tension and ionic strength similar to human skin. Besides the fact that improvements in mimicking human skin properties are always desirable, one major drawback of Vitro-Skin® is that before the material can be used for testing, extensive pre-conditioning under relatively high humidity and specific temperature for a rather lengthy period of time is required. After this time consuming pre-treatment, the products are weak and difficult to handle.

### SUMMARY OF THE INVENTION

It is an object of the invention to provide a protein based film that can be used for in vitro testing of cosmetic ingredients and end products.

It is further an object to provide a protein based film for cosmetic testing that is ready to use.

It is also an object of the invention to provide a protein based film that can be used in a flexible way for in vitro testing of cosmetic products or cosmetic product ingredients either as free film or applied to or adhered onto a supporting base material, enabling easy handling.

Surprisingly, it has been found that the above objects can be met by a protein based film which has a specified humidity. In one embodiment the protein based film is provided as free film. In one embodiment the protein based film is provided as a filom on a supporting base. The basis of the film is protein. The degree or amount of humidity is controlled by the addition of a humidity controlling agent to the solution from which the film is formed. The process of preparing a film according to the present invention includes a drying step that should be carefully conducted to arrive at a protein based film having the required degree or amount of humidity. Advantageously the so prepared protein based film can be packaged in such a way that the humidity of the film stays within the desired range, thereby ensuring that the film is ready to use at the moment it is removed form its packaging. Also advantageously the protein based film can be provided with a backing support, for example a base material onto which the protein based film may be adhered permanently or temporarily. The transparency of the protein based film of the invention makes it particularly suitable for testing involving light measurements, including UV-light and light absorption measurements.

Thus the invention concerns a protein based film, said film comprising protein and a humidity control agent and said film having preferably a humidity content of at least 10 wt % and at most 25 wt %, based on the total weight of the film.

In one embodiment the film is suitable for in vitro testing of compositions that are to be applied onto skin and ingredients of compositions that are to be applied onto skin

### DETAILED DESCRIPTION OF THE INVENTION

The protein based film according to the invention is based on a cross-linked protein, optionally provided with a backing support. Several additives may give the film unique properties such as surface tension, surface roughness, water-uptake (swelling), water resistance, mechanical strength, hydrophobicity, and the like.

A unique and major advantage over the commercially available VitroSkin, is that the film of the present invention is ready-to-use. Hence there is no need for laborious high humidity preconditioning prior to use.

The basis of the film according to the invention, which renders this material suitable for use as a skin model or substitute skin for in vitro testing purposes and in fact provides the film with its excellent in vitro testing properties, is formed by a protein layer. The dry thickness of the film of this invention typically may be between 1 μm and 300 μm. In one embodiment the thickness of protein based film is between 2 and 150 μm, in another embodiment the thickness of protein based film is between 2 μm and 100 μm.

Within the context of this invention the term protein, which includes polypeptides, is to be understood so as to comprise any molecule having at least 15 amino acids linked by peptide bonds, including natural proteins, denatured proteins, synthetic and recombinant proteins and peptides, glycoproteins, proteoglycans, lipoproteins and other molecules which may contain other groups, including bio-oligomer or polypeptide groups, also as a side chain. It is also possible to use chemically modified proteins either solely or in combination with non-modified proteins. The film comprises at least 30 wt % protein, based on the total weight of the film, but not more than 90 wt % protein based on the total weight of the film.

In a preferred embodiment the protein in the protein based film of this invention is gelatine. Gelatines which for example can be used as the protein, or polypeptide, are acid or lime treated skin or bone gelatines from mammals or cold-blooded animals. Such gelatines are common in the prior art and are well described in literature. Molecular weights of such naturally isolated gelatines may range from about 2.5 or 7.5 to about 300 kDa. Commercially available gelatine may be used according to the present invention. Suitable molecular weights of gelatines to apply in the film of the invention preferably lie in the range from 10 kDa to 200 kDa. In one embodiment gelatines with a molecular weight of at least 20 kDa or at least 40 ka, or at least 60 kDa, or at least 80 kDa or at least 100 kDa may be used. In one embodiment gelatines with a molecular weight of less than 300 kDa, or less than 250, or less than 200 kDa may be used. It is also possible to use chemically modified gelatines either solely or in combination with non-modified gelatine. Examples of modified gelatines include, but are not limited to, trimellitated, succinylated, acylated, alkylated, phthalated gelatine. Modified gelatines can advantageously be used for example to tune interaction between the certain ingredients or (cosmetic) products and the sheet material for in vitro testing. Also recombinant gelatines may be used. Recombinant gelatin (also referred to as recombinant collagen or recombinant collagen-like peptides) typically refers to one or more gelatin or gelatin-like polypeptides produced by recombinant methods, such as by expression of a nucleotide encoding the peptide in a micro-organism, insect, plant or animal host. Such peptides are characterized by comprising Gly-Xaa-Yaa triplets wherein Gly is the amino acid glycine and Xaa and Yaa can be the same or different and can be any known amino acid. At least 40% of the amino acids are preferably present in the form of consecutive Gly-Xaa-Yaa triplets. More preferably at least 60%, even more preferably at least 80% or even more than 90% of the amino acids are present in the form of Gly-Xaa-Yaa triplets. Preferably, the peptides have a molecular weight of about 2.5 kD or more. More preferred are molecular weights of between about 2.5 to about 100 kD or between about 5 to about 80 kD.

In general the humidity control agent is a non- or only slightly volatile organic compound that has water-binding capacity. The humidity control agent can be water-miscible or non-soluble in water. Depending on its inherent properties, the humidity control agent can be dissolved or emulsified in an aqueous solution from which the protein based film is formed. The humidity control agent can also be introduced in the coating solution by carrier vehicles such as solid particles, hollow spheres, polymers, and the like.

In one embodiment the active humidity controlling agent is selected from the group consisting of glycol, glycerol, ethylene glycol, diethylene glycol, propylene glycol, polyethylene glycol, polypropylene glycol, acrylic acid, any polymerised form of acrylic acid, glyceryl triacetate, sorbitol, mannitol, lactitol, xylitol, erythritol, maltitol, lactate salts, polydextrose, acetamide, glycereth, lactamide, hyaluronic acid, echinacin, and the like.

The amount of humidity control agent is between 2 and 100%, preferably between 5 and 80% and more preferably between 10 and 60% by weight based on the weight of the protein in the film. In one embodiment the amount of humidity control agent is between 10-60 g per 100 g protein.

In one embodiment it may be advantageous to increase the physical strength of the film and improve the water resistance of the film. In order to achieve this, the protein film, optionally in combination with additives, may be hardened with a suitable hardener or crosslinking agents. At least 0.1 up to 20 wt % crosslinking agent may be added, preferably between 0.5 and 5 wt %, based on the weight of the protein in the film.

Suitable crosslinking agents are described in EP A 1 437 229. Thus the crosslinking agent may be one or more of aldehyde-based compounds such as formaldehyde, glyoxal, glutaraldehyde and the like; a ketone-based compound such as diacetyl, cyclopentanedione and the like; an activated halide such as bis(2-chlorethylurea), 2-hydroxy-4,6-dichloro-1,3,5-triazine, 2,4-dichloro-6-S-triazine sodium salt and the like; an activated vinyl compound such as divinylsulfonic acid, 1,3-vinylsulfonyl-2-propanol, N,N′-ethylenebis(vinylsulfonylacetamide), 1,3,5-triacryloylhexahydro-S-triazine and the like; an N-methylol compound such as dimethylol urea, methylol dimethylhydantoin and the like; a melamine resin (for example, methylol melamine, alkylated methylol melamine); an epoxy resin; an isocyanate compound such as 1,6-hexamethylene diisocyanate and the like; aziridine compound described in U.S. Pat. No. 3,017,280 and U.S. Pat. No. 2,983,611; a carboxyimide compound described in U.S. Pat. No. 3,100,704; an epoxy-based compound such as glycerol triglycidyl ether and the like; an ethyleneimino-based compound such as 1,6-hexamethylene-N,N′-bisethylene urea and the like; a halogenated carboxyaldehyde-based compound such as mucochloric acid, mucophenoxychloric acid and the like; a dioxane-based compound such as 2,3-dihydroxydioxane and the like; a boron compound such as boric acid, borax and borate; a metal-containing compound such as titanium lactate, aluminum sulfate, chromium alum, potassium alum, zirconyl acetate, chromium acetate and the like, a polyamine compound such as tetraethylene pentamine, a hydrazide compound such as adipic acid dihydrazide, a low molecular weight compound or polymer having two or more oxazoline group and the like. These crosslinking agents can be used alone or in combination.

In another embodiment it may be advantageous to adjust the surface roughness of the sheet material to the desired properties by including solid particles or beads in the protein based film, for example by adding solid particles or beads to the solution from which the film is formed. Solid particles or beads may or may not be present in addition to the presence of cross linking agents. Such surface roughness influencing solid particles can be organic particles such as polystyrene, or polymethylmethacrylate, or inorganic particles such as silicium oxide, aluminium oxide, titanium oxide, iron-oxide, and the like. Also mixtures of various particle types are possible. The solid particles preferably have a size between 1 and 200 μm, more preferably between 2 and 100 μm. The optimal size depends on the application and on the thickness of the film. The amount of solid particles is between 0.01 g/m² and 50 g/m², preferably between 0.1 g/m² to 10 g/m² of film.

Further it may be beneficial to include suitable surfactants that can aid the film forming process and/or tune the surface tension of the film of this invention. One or more suitable surfactant may be chosen to enhance application of the cosmetic products/ingredients on the film and to mimic surface tension of the human skin as much as possible. Examples of suitable surfactants that may be present in the film of this invention, for example by adding them to the film forming solution, include Preferably surfactants should be chosen that comply with the nature of the film forming solution.

In one embodiment one or more anionic surfactants are present in the film. Examples of suitable anionic surfactants include alkylsulfocarboxylates, alpha-olefin sulfonates, polyoxyethylene alkyl ether acetates, N-acylaminoacids and salts thereof, N-acylmethyltaurine salts, alkylsulfates, polyoxyalkylether sulfates, polyoxyalkylether phosphates, rosin soap, castor oil sulfate, lauryl alcohol sulfate, alkylphenol phosphates, alkyl phosphates, alkyl allyl sulfonates, diethylsulfosuccinates, diethylhexylsulfosuccinates and dioctylsulfosuccinates.

In one embodiment one or more cationic surfactants are present in the film. Examples of suitable cationic surfactants include 2-vinylpyridine derivatives and poly-4-vinylpyridine derivatives.

In one embodiment one or more amphoteric surfactants are present in the film. Examples of suitable amphoteric surfactants include lauryl dimethyl aminoacetic acid betaine, 2-alkyl-N-carboxymethyl-N-hydroxyethyl imidazolinium betaine, propyldimethylaminoacetic acid betaine, polyoctyl polyaminoethyl glycine, and imidazoline derivatives.

In one embodiment one or more non-ionic surfactants are present in the film. Examples of suitable non-ionic surfactants include non-ionic fluorinated surfactants and non-ionic hydrocarbon surfactants. Useful examples of non-ionic hydrocarbon surfactants include ethers, such as polyoxyethylene nonyl phenyl ether, polyoxyethylene octyl phenyl ether, polyoxyethylene dodecyl phenyl ether, polyoxyethylene alkyl allyl ethers, polyoxyethylene oleyl ethers, polyoxyethylene lauryl ethers, polyoxyethylene alkyl ethers, polyoxyalkylene alkyl ethers; esters, such as polyoxyethylene oleate, polyoxyethylene distearate, sorbitan laurate, sorbitan monostearate, sorbitan monooleate, sorbitan sesquioleate, polyoxyethylene monooleate and polyoxyethylene stearate; and glycol surfactants. Specific examples of nonionic surfactants include octylphenoxy polyethoxy ethanols, such as Triton™ X-100, X-114 and X-405, available from Union Carbide Co., Danbury, Conn.; acetylenic diols such as 2,4,7,9-tetramethyl-5-decyn-4,7-diol and the like, such as Surfynol™ GA and Surfynol™ CT-136, available from Air Products & Chemicals Co., Allentown, Pa.; trimethyl nonylpolyethylene-glycol ethers, such as Tergitol™ TMN-10 (containing 10 oxyethylene units, believed to be of formula C₁₂H₂₅O(C₂H₄O)₅H), available from Union Carbide Co., Danbury, Conn.; non-ionic esters of ethylene oxide, such as Merpol™ SH (believed to be of formula CH₃(CH₂)₁₂(OC₂H₄)₈OH), available from E. I. Du Pont de Nemours & Co., Wilmington, Del.; non-ionic esters of ethylene oxide and propylene oxide, such as Merpol™ LFH (believed to be of formula CH₃(CH₂)ₙ(OC₂H₄)₈(OC₃H₆)₈OH, where n is an integer from 12 to 16), available from E. I. Du Pont de Nemours & Co., Wilmington, Del., and the like, as well as mixtures thereof.

Examples of suitable non-ionic fluorinated surfactants include linear perfluorinated polyethoxylated alcohols (e.g., Zonyl™ FSN, Zonyl™ FSN-100, Zonyl™ FSO, and Zonyl™ FSO-100 available from DuPont Specialty Chemicals, Wilmington, Del.), fluorinated alkyl polyoxyethylene ethanols (e.g., Fluorad™ FC-170C available from 3M, St. Paul, Minn.), fluorinated alkyl alkoxylate (e.g., Fluorad™ FC-171 available from 3M, St. Paul, Minn.), fluorinated alkyl esters (e.g., Fluorad™ FC-430, FC-431, and FC-740 available from 3M, St. Paul, Minn.) and fluorine-substituted alkyl esters and perfluoroalkyl carboxylates (for example, the F-tergent series manufactured by Neos Co., Ltd., the Lodyne series manufactured by Ciba-Geigy, the Monflor series manufactured by ICI, the Surfluon series manufactured by Asahi Glass Co., Ltd., and the Unidyne series manufactured by Daikin Industries, Ltd.).

Preferred nonionic fluorocarbon surfactants include Zonyl™ FSO, Fluorad™ FC-170C, and Fluorad™ FC-171.

In one embodiment the above mentioned surfactants are applied in concentrations ranging from 0.01 to 1.0 g/m², preferably from 0.05 to 0.50 g/m² of film.

Other surfactants to adjust the surface properties of the film of this invention can be water insoluble organic compounds such as silicones. In one embodiment the film includes a silicone selected form the group of linear polydimethylsiloxane (PDMS) and cyclic siloxanes, e.g. octamethyltetracyclosiloxane (OCS). The molecular weight of the PDMS should be chosen to be in accordance with the properties of the film forming solution. Preferably the PDMS compound has a viscosity between 10 and 50000 cP as a pure compound at room temperature (20° C.).

Water soluble polymers can be included in the film of this invention to alter its mechanical or chemical properties. The sheet material may comprise at least 0.1 g up to 40 g of water soluble polymer per 100 g of protein. Preferably the amount of water soluble polymer is between 0.5 and 30 g per 100 g of protein. Suitable water soluble polymers are described in for example EP-A-1 437 229. Thus the water soluble polymer may be one or more of a polyvinyl alcohol-based resin which is a resin having a hydroxy group as a hydrophilic structure unit (e.g. polyvinyl alcohol (PVA), acetoacetyl-modified polyvinyl alcohol, cation-modified polyvinyl alcohol, anion-modified polyvinyl alcohol, silanol-modified polyvinyl alcohol, polyvinyl acetal and the like), a cellulose-based resin (methyl cellulose (MC), ethyl cellulose (EC), hydroxyethyl cellulose (HEC), carboxymethyl cellulose (CMC), hydroxypropyl cellulose (HPC), hydroxyethylmethyl cellulose, hydroxypropylmethyl cellulose and the like), chitins, chitosans, starches, ether bond-carrying resins (polyoxyethylene oxide (PEO), polypropylene oxide (PPO), polyethylene glycol (PEG), polyvinyl ether (PVE) and the like), a carbamoyl group-carrying resin (polyacrylamide (PAAM), polyvinyl pyrrolidone (PVP), polyacrylic acid hydrazide and the like), as well as polyacrylates having carboxyl groups as free groups, maleic acid resins, alginates and the like. Suitable copolymers of PVA are disclosed in WO-A-03/054029, like for example PVA-NVF copolymers.

In one embodiment polyglycols are used in the film of this invention for reasons of humidity control agent as well as for use as a polymer to improve the mechanical and/or chemical properties of the film of this invention.

Other additives that may optionally be added to the film of this invention include biocides, dyes, either organic or pigment type, UV-absorbing agents, mordants, optical brighteners, antioxidants, antistatic agents, light stabilising agents, etc.

Agents which can be used, in general, as a biocide, for example as a preservative and/or antifungal agent, can include, for example, aromatic hydroxy compounds such as phenol, thymol, trichlorophenol, tetrachlorophenol, pentachlorophenol, cresol, p-chloro-m-cresol, o-phenylphenol, benzylphenol, 2-benzyl-4-chlorophenol, 35 chlorophen, dichlorophen, bromochlorophen, 2,2′-dihydroxy-5,5′dichlorodiphenyI monosulfide, 2,4,4′ trichloro-2′hydroxydiphenyl ether, 3,4,5-tribromosaticyl anilide, or the salts thereof; compounds containing a carbonyl group such as formaldehyde, paraformaldehyde, chloroacetaldehyde, glutaraldehyde, chloroacetamide, methylol chloroacetamide; carboxylic acids or esters thereof such as benzoic acid, monobromoacetic acid esters, p-hydroxybenzoic acid esters, sorbic acid; amines such as 40 hexamethylenetetramine, alkylguanidines, nitromethylbenzylethylenediamine; disulfides such as tetramethylthiurarn disulfide; nitrogen-containing heterocyclic compounds such as 2-mf.rcapto benzothiazole, 2-(4-thiazolyl)benzimidazole, 2methoxycarbonylaminobenzimidazole; organic mercury compounds such as mercury phenylacetate, mercury phenylpropionate, mercury phenyloleate; antibiotics such as neomycin, kanamycin, polymycin, streptomycin, furamycin, and the like

In one embodiment the film according to the invention is provided with a backing substrate.

The backing substrate, or supporting base, can in one embodiment be opaque, for example paper with or without polyethylene lamination layer, or in one embodiment the backing substrate can be transparent, such as triacetyl cellulose (TAC), polyesters, polyethyleneterephtalate (PET), polyethylenenaphtalate (PEN), polysulfone, polyphenylene oxide, polyamide, polycarbonate, and the like. The type of substrate can be chosen in accordance with requirements for testing. For example in tests were transparency for visible and UV-light is vital, one can choose for TAC. When a peelable film of sheet material is required preferably polyethylene laminated base paper is used. Surprisingly addition of the humidity control agent also governs the stickiness of the sheet material to the backing substrate.

The thickness of the backing substrate is not particularly limited, however 50 to 300 μm is suitable from a practical viewpoint.

Optionally a subbing layer can be present on the supporting backing substrate to enhance attachment of the sheet material. A suitable subbing material is for instance a gelatin.

When adhered to a backing substrate, the film need not to have internal strength and optimal thickness of the sheet material is determined by properties such as water uptake, transparency, surface roughness and the like. In one embodiment, when adhered to a backing substrate, the dry thickness of the film is typically between 2 and 150 μm.

In order to make a solution from which the film is to be formed (in other words film forming solution), protein is dissolved or dispersed in a suitable volatile solvent, preferably at least 50% water. The use of co-solvents can be advantageous to dissolve specific ingredients of the film forming solution or to improve film formation. Co-solvents should preferably be volatile solvents that can be sufficiently removed by drying.

Solid, dispersed, or dissolved crosslinking agents can be added to the film forming solution just before film formation or can be applied as an overcoating, i.e. a coating on top of the film in which the crosslinking agent is applied.

Further, suitable surfactants, water soluble polymers and other additives described above may be added to the protein containing film forming solution.

A further aspect of the invention concerns the solution from which the film is formed. The solution for forming a protein based film according to the invention comprises from 5 to 25 wt % dissolved protein, preferably gelatine as defined above, and preferably dissolved in a solution comprising at least 50 wt % water; between 2 and 100%, preferably between 5 and 80% and more preferably between 10 and 60% by weight based on the weight of the protein of a humidity control agent; between 0.1 and 20 wt %, preferably between 0.5 and 5 wt %, based on the amount of protein of a crosslinking agent as defined above; and surface roughness influencing solid particles as defined above in such an amount that between 0.01 g/m² and 50 g/m², preferably between 0.1 g/m² and 10 g/m² of film is obtained. Optionally the solution comprises one or more additives. The solution may comprise a surfactant in an amount of between 0.01 and 0.1 wt %, of the solution and or water soluble polymers in an amount between 0.1 g and 40 g, preferably between 0.5 and 30 g, per 100 g of protein. Furthermore the solution may comprise biocides, dyes, either organic or pigment type, UV-absorbing agents, mordants, optical brighteners, antioxidants, antistatic agents and light stabilising agents. The pH of the film forming solution is preferably between 2 and 10, more preferably between 4 and 9, and most preferably between 5 and 8.

A film according to the present invention that is self-supporting can be prepared by methods known in the art for casting films. For example a film forming solution is coated on a cooling drum, where it solidifies. Via a take up roll the continuous film is removed from the cooling drum and dried to the required humidity in the drying process. The film is slitted to the required size and packed.

Another preferred method for making a self supporting film, is coating a film forming solution via a coating process onto a substrate with a low surface tension. The coating method used can be selected from curtain coating, extrusion coating, air-knife coating, slide coating, roll coating, reverse roll coating, dip coating, rod bar coating and the like. After cooling and drying the formed film can be removed from the substrate as the adhesion to the substrate of the film is very poor. Another advantage of this method is, that one surface of the film (the surface in direct contact with the substrate) is a negative of the surface characteristics of the substrate, by which the texture of the surface of the film can be controlled.

The film of this invention on a backing substrate can be prepared using a single or multi-layer coating process. As a coating method, any method suitable for coating of films can be used. For example, curtain coating, extrusion coating, air-knife coating, slide coating, roll coating, reverse roll coating, dip coating, rod bar coating are suitable. The coating can be done simultaneously or consecutively, depending on the embodiments used.

Before applying the coating to the surface of the backing support described above, the backing support may be subjected to a corona discharge treatment, glow discharge treatment, flame treatment, ultraviolet light irradiation treatment and the like, for purposes of improving wettability and adhesiveness.

After film formation, the film is dried. In principle any drying method used for drying sheet-like materials, e.g. films, may be applied. Drying of the film should be done carefully in order not to dry out the film. Drying conditions should be tuned in order to keep the final humidity content of the sheet material between 10 wt % and 25-wt %, based on the total weight of the film, hence without the weight of the backing substrate, to ensure ready to use material which is flexible without being brittle.

Herein the humidity content is determined by the weight of the film (hence without backing substrate) after treatment, i.c. keeping the film, at 105° C. for 24 hours relative to the weight of the film without backing substrate before said treatment. The humidity content is calculated by subtracting the weight of the film after treatment from the weight of the film before treatment and then dividing the outcome by the weight of the film before treatment and then multiplying the outcome with 100%. When the humidity content is too high, sticky material is obtained which is difficult to handle. When the humidity content is too low brittle material is obtained. In view of the tackiness of the surface of the film, flexibility of the film and the stickiness of the film to a backing substrate it is advantageous that the humidity content of the film is between 10 wt % and 25 wt % and preferably between 12 wt % and 25 wt %. The humidity content of the film may be at least 10, 12, 14 or 15 wt % and at most 25, 22 or 20 wt %.

The invention thus also concerns a process for preparing an optionally packaged film, said process comprising the steps of forming a film, optionally onto a backing substrate, said film comprising protein and humidity control agent as defined above, according to a method known per se and subsequently drying said film under conditions so as to obtain a final humidity content of the film between 10 wt % and 25 wt %, based on the total weight of the film and optionally packaging the sheet material thus obtained in a container which is suitable to keep the humidity content of the film between 10 wt % and 25 wt % based on the total weight of the film. In one embodiment of the process, the film is formed from a film forming solution as defined above.

The film prepared according to the process described above can be used immediately. It may also be advantageous to store the film for later use. In view of later use, in order to keep the film in good condition and keep the humidity content stable, proper packaging of the film is recommended. Packaging of the film may comprise any suitable plastic film material, such as linear low-density polyethylene, for example. The packaging may comprise multiple plies. An outer ply may be a barrier lamination including a layer made from a foil material or a suitable metallized substrate, or any other recognized flexible barrier or substrate materials including non-metallized materials. An outer barrier lamination suitably comprises an outer layer of nylon, an intermediate layer or foil, and an inner layer of polyethylene. Alternatively, the barrier lamination could comprise an outer layer of polyethylene, an intermediate layer of metallized nylon, or metallized polyester, or metallized polyvinyl alcohol, and an inner layer of polyethylene. Preferably the packaging is air-sealed more preferably the packaging is air-sealed with a preservative or under an inert atmosphere. Preferably it is prevented that the film might dries out when exposed to low humidity atmospheric conditions.

Thus in a further aspect the invention concerns a film of this invention, which is packed in a suitable container to keep the film such that it is ready to use, upon removal from the container. Ready to use means that the sheet material does not require a pre-conditioning step to render it suitable for testing conditions.

Also an aspect of the present invention is the use of the film in in vitro testing of make-up smearing, colour evaluation, sun protection factor measurements, UVA-protection, water resistance, sunless tanning applications of cosmetic formulations or of ingredients for cosmetic products and the like.

### Examples

### Example 1

### Preparation of the Sample Films

TABLE I
Overview of different recipes for protein based films

| Recipe | A | B | C | D | E | F | G | H | I | unit |
|---|---|---|---|---|---|---|---|---|---|---|
| Limed ossein gelatine | 3000 | 3000 | 3000 | 3000 | 3000 | 3000 | 3000 | 3000 | 3000 | g |
| Water | 11500 | 11500 | 11500 | 11500 | 11500 | 11500 | 11500 | 11500 | 11500 | g |
| benzo[d]isothiazol-3(2H)-one, | 150 | 150 | 150 | 150 | 150 | 150 | 150 | 150 | 150 | g |
| 7% in water | | | | | | | | | | |
| 35% silica suspension in water | 650 | 650 | 650 | 650 | 650 | 650 | 650 | 650 | 650 | g |
| (mesh size 40-60 μm) | | | | | | | | | | |
| 10% Aerosol OT solution in | 125 | 125 | 125 | 125 | 250 | | 125 | 125 | 125 | g |
| water | | | | | | | | | | |
| 10% sodium 4-dodecyl | | | | | | 125 | 125 | | | g |
| benzenesulfonate (SDBS) | | | | | | | | | | |
| 50% Polyacrylamide solution in | 1000 | 1000 | 1000 | | | | | | | g |
| water | | | | | | | | | | |
| Ethylene glycol | 0-3000 | 1500 | 1500 | 1500 | 1500 | 1500 | 1500 | | | g |
| Glycerol | | | | | | | | 1500 | | g |
| Polyacrylicacid | | | | | | | | | 1500 | g |
| Polydimethylsiloxane | 250 | | 500 | 500 | 500 | 500 | 500 | 500 | 500 | g |
| Octamethyltetracyclosiloxane | 250 | 500 | | | | | | | | g |
| (OCS) | | | | | | | | | | |
| 1 M sodium hydroxide | 400 | 400 | 400 | 400 | 400 | 400 | 400 | 400 | 400 | ml |
| 7.5% 2-hydroxy-4,6-dichloro- | 1500 | 1500 | 1500 | 1500 | 1500 | 1500 | 1500 | 1500 | 1500 | ml |
| 1,3,5-triazine | | | | | | | | | | |

Preparation Procedure

The film forming solutions were prepared as follows. First an aqueous gelatine solution (limed ossein gelatine, molecular weight 180 kD) was prepared at 40° C. While stirring at low speed (to avoid air entrapment) the following additions were performed in succession: solution of biocide benzo[d]isothiazol-3(2H)-one, suspension of silica, solution of surfactant (Aerosol OT/SDBS), solution of polyacrylamide, humidity control agent (glycol/glycerol/polyacryclic acid), polydimethylsiloxane and/or OCS, sodium hydroxide. The solution was mixed for 1 hour at 40° C. at relatively low speed. The solutions were then de-aerated by ultrasonication. Just before film formation the hardener 7.5% 2-hydroxy-4,6-dichloro-1,3,5-triazine was added.

From the above solution a film was formed by applying the solution onto a backing substrate either by hand coating or using a slide coating machine. In all examples a film having a coated wet thickness of 400 μm was used. Optionally electrostatic charging was applied to improve the coatability. The solutions were coated on polyethylene laminated base paper.

Drying was performed at 20° C. and 50% relative humidity for 16 hours after which the materials were cut and received an after treatment of 35° C. at 70% relative humidity for 48 hours. Hereafter the materials were packaged in air-sealed plastic bags until further use. All sample films can be used as an advanced test sheet. Below some further examples are given for a specific test sheet formulation.

### Example 2

### Illustration of the Effect of Humidity Controlling Agent

The water content of samples A, prepared with glycol as humidity controlling agent, coated on PE laminated paper was measured according to the following procedure. The sheet material was peeled off from the substrate and cut into a defined size of 10 cm². The material was weighed on an analytical weighing device. Then the samples were exposed for at least 16 hours to a temperature of 105° C. in a heating oven. Hereafter the samples were weighed again and the weight loss was calculated to be the water content of the sample. The water content, flexibility, tackiness, and stickiness to the PE are shown in table 2 as a function of glycol amount.

TABLE 2
The water content, flexibility, tackiness, and
stickiness to PE as a function of glycol amount

| | Glycol amount | Water content | | | |
|---|---|---|---|---|---|
| | (weight % of | (wt % of sheet | Tackiness | | Stickiness |
| Sample | gelatin) | material) | of surface | Flexibility | to PE |
| A1 | 0 | 10 | Absent | Brittle | None |
| A2 | 10 | 11 | Absent | Slightly brittle | None |
| A3 | 20 | 14 | Absent | Slightly brittle | Slight |
| A4 | 30 | 16 | Absent | Flexible | Sticking |
| A5 | 40 | 18 | Absent | Very flexible | Sticking |
| A6 | 50 | 20 | Absent | Very flexible | Sticking |
| A7 | 60 | 25 | Slightly tacky | Very flexible | Sticking |
| A8 | 70 | 30 | Tacky | Very flexible | Sticking |
| A9 | 100 | 35 | Tacky | Very flexible | Sticking |

In the above series unambiguously the humidifying effect of glycol is shown. It has great impact on the humidity content of the film and hence its flexibility. Addition of humidity control agent therefore is essential to obtain ready to use material. The optimal glycol concentration depends on the tackiness of the surface. For concentrations above 60% the surface becomes quite tacky. Sheet materials prepared with glycol concentrations of more than 10% are sticking to the PE laminated substrate. These films can be peeled off without damaging the film. A big advantage of the peelable film is that it can easily be cut to the desired size or handled before peeling off the sheet (in case a free film is required in the application test).

### Example 3

### Use of Material for in Vitro Testing

The films of example 1 can excellently be used for sun protection factor (SPF) measurements of sun creams. Hereto films supported by TAC was used for reasons of its transparency for UV-radiation. Films prepared with recipes A4, C and H were used, which were taken out of their plastic bag packing just before use. Several sun creams were applied to the surface of the film with an amount of 2 μL/cm². The sun cream was rubbed in and dried for ca 15 minutes. Hereafter the sheet was put in a UV-spectrophotometer using the integrating sphere and the UV-spectrum was measured against a blanc of the same sheet without sun cream. The theoretical SPF factor is calculated from the recorded UV-spectrum using the method as described in B. L. Diffey and J. Robson, J. Soc. Cosmet. Chem., 40(1989) pp 127-133

As a reference Vitro-Skin®, a commercially available sheet material was taken. This material was pre-treated for 16 hrs at 95% humidity according to the manufacturer's instructions (IMS-USA). Hereafter sun creams were applied as described by the supplier.

As seen in Table 3 the SPF factors measured on the film of this invention are in good accordance with those measured by the reference material and are in good correlation with SPF factors indicated by the commercial creams used. Hence it is shown that in case of the invention pre-treatment is redundant.

TABLE 3
comparison of SPF values indicated on commercial sun creams with measured
SPF values on the test sheet of this invention and reference material.

| | | Measured SPF on Invention | | | |
|---|---|---|---|---|---|
| | SPF Indicated | Test Sheet | | | Measured SPF on Vitro- |
| Product | on package | A4 | C | H | Skin ® reference |
| Nivea sun milk SPF4 | 4 | 3.5 | 4.2 | 4.5 | 3.2 |
| Nivea sun milk SPF12 | 12 | 11.0 | 13.0 | 12.5 | 12.5 |
| Ambre Solaire sun | 16 | 14.0 | 15.0 | 15.2 | 14.5 |
| milk SPF16 | | | | | |

1. A protein based film comprising protein and a humidity control agent, the film having a humidity content between 10 wt % and 25 wt % based on the total weight of the film.

2. The film according to claim 1, wherein the protein is gelatine or a derivative thereof.

3. The film according to claim 1, wherein the humidity control agent is selected from the group consisting of glycol, glycerol, ethylene glycol, diethylene glycol, propylene glycol, polyethylene glycol, polypropylene glycol, acrylic acid, any polymerised form of acrylic acid, glyceryl triacetate, sorbitol, mannitol, lactitol, xylitol, erythritol, maltitol, lactate salts, polydextrose, acetamide, glycereth, lactamide, hyaluronic acid, echinacin and mixtures thereof.

4. The film according to claim 1, further comprising 0.1 to 20 wt % based on the amount of protein of a crosslinking agent.

5. The film according to claim 1, further comprising surface roughness influencing solid particles in an amount of between 0.01 g/m² to 50 g/m².

6. The film according to claim 1, further comprising one or more additives selected from the group consisting of surfactants, biocides, dyes, UV-absorbing agents, mordants, optical brighteners, antioxidants, antistatic agents and light stabilising agents.

7. The film according to claim 1, which is provided with a backing substrate.

8. The film according claim 7, wherein the backing substrate is transparent.

9. The film according to claim 8, wherein the backing substrate is selected from the group consisting of triacetate (TAC), polyesters, polyethyleneterephtalate (PET), polyethylenenaphtalate (PEN), polysulfone, polyphenylene oxide, polyamide and polycarbonate.

10. The film according to claim 7, wherein the backing substrate is opaque.

11. The film according to claim 10, wherein the backing substrate comprises paper with or without polyethylene lamination layer.

12. The film according to claim 7, wherein the film can be peeled from the backing substrate.

13. A solution for forming a film comprising:
(a) from 5 to 25 wt % dissolved protein;
(b) between 2 and 100%, based on the weight of the protein, of a humidity control agent;
(c) between 0.1 and 20 wt %, based on the amount of protein, of a crosslinking agent; and,
(d) surface roughness influencing solid particles in such an amount that between 0.01 g/m² and 50 g/m² of film is obtained.

14. The solution according to claim 13, further comprising one or more additives selected from the group consisting of surfactants, biocides, dyes, UV-absorbing agents, mordants, optical brighteners, antioxidants, antistatic agents and light stabilising agents.

15. A process for preparing a film, said process comprising:
(a) forming a film from a solution according to claim 13; and,
(b) subsequently drying said film to a humidity content between 10 wt % and 25 wt %, based on the total weight of the film.

16. The process according to claim 15, further comprising: (c) packaging the film in a container which is suitable to keep the humidity content of the film between 10 wt % and 25 wt % based on the total weight of the film.

17. The process according to claim 16, wherein said film is formed from a solution further comprising one or more additives selected from the group consisting of surfactants, biocides, dyes, UV-absorbing agents, mordants, optical brighteners, antioxidants, antistatic agents and light stabilising agents.

18. A film according to claim 1, which is packed in a suitable container to keep the sheet material with a humidity content of the film between 10 wt % and 25 wt %, based on the total weight of the film.

19. A method of in vitro testing of a cosmetic product and/or ingredient therein for make up smearing, colour evaluation, sun protection factor measurements, UVA-protection, water resistance, sunless tanning applications, the method comprising applying the cosmetic product and/or ingredient therein upon a film according to claim 1.

20. The process according to claim 15, wherein the film is formed onto a backing substrate.

21. The solution according to claim 13, wherein the protein is dissolved in a solution comprising at least 50 wt % water.
